(19) United States
(12) Patent Application Publication
(10) Pub. No.: US 2026/0171870 A1
(43) Pub. Date: Jun. 18, 2026

(54) HEAT DISSIPATION STRUCTURE FOR BLOWER MOTORS

(71) Applicant: PIN SHENG METAL INDUSTRIAL CO., LTD., Taichung City (TW)

(72) Inventors: Wan Chen KO, Taichung City (TW); Yu Jen KO, Taichung City (TW)

(21) Appl. No.: 18/978,900

(22) Filed: Dec. 12, 2024

(51) Int. Cl. H02K 9/06; H02K 5/20

(52) U.S. Cl. CPC H02K 9/06; H02K 5/207; H02K 2205/09

(57) ABSTRACT

A heat dissipation structure for a blower motor comprises a motor and a fan assembly. The motor has an output shaft, and the fan assembly includes at least one impeller mounted on the end of the output shaft. Each impeller comprises a fan disc with multiple equidistantly arranged blades around its periphery. An airflow directing assembly is positioned on the fan disc surface adjacent to the motor and comprises multiple airflow directing vanes arranged radially at equal angles. Each airflow directing vane has a cross-section at the end consisting of a thinner vane leading edge near the motor and a thicker vane trailing edge adjoining the fan disc surface. This design uses the airflow directing assembly to direct the airflow, effectively expelling internal heat from the motor through rotation of the impeller, ensuring efficient heat dissipation and cooling, and extending the life of the motor.

### FIELD OF INVENTION

The present invention relates to the technical field of blowers and more particularly to a heat dissipation structure for blower motors.

### BACKGROUND OF THE INVENTION

Blowers are extensively used in various environments where air exchange or exhaust is required, such as kitchens and cookers to facilitate the rapid removal of fumes. Conventional blower structures typically comprise a hollow housing and a fan assembly, wherein the housing contains an eccentric exhaust outlet located at the top and inlet ports located on opposite sides. A motor is mounted within the housing between the two inlet ports, and the fan assembly has impellers mounted on two output shafts at the ends of the motor. When the motor drives the impellers on both sides to rotate at high speeds, air is drawn into the housing through the inlet ports on both sides and expelled through the exhaust outlet at the top by centrifugal action.

Since the motor is positioned between the impellers of the fan assembly on both sides, high-speed operation creates an enclosed air chamber between the two impellers, which hinders the discharge of the airflow and results in vortex formation, which also results in the heat generated by the motor during operation not being effectively dissipated. This inefficiency in heat dissipation and cooling significantly affects the performance of the motor and can lead to overheating. If the elevated temperatures are not alleviated, the motor may sustain damage, thereby affecting the air delivery performance of the blower and shortening motor's service life.

In summary, the existing blowers encounter challenges related to motor heat dissipation, making it difficult to effectively cool the motor during operation. Addressing these issues is of critical importance to both the industry and users. The present invention seeks to resolve these issues by providing an improved heat dissipation structure for blower motors.

In light of the above shortcomings and industry demands, the inventor believes that there is a need for further improvement and, drawing on his extensive experience in related technologies and product design, the inventor has undertaken extensive research and prototyping to develop an innovative heat dissipation structure for blower motors. The present invention effectively addresses the limitations and operational inefficiencies associated with poor motor heat dissipation in conventional blowers.

### SUMMARY OF THE INVENTION

The main purpose of the present invention is to provide a heat dissipation structure for blower motors which enables the effective discharge of internal airflow from the motor, preventing the formation of enclosed air chambers caused by high-speed vortices, thereby achieving efficient heat dissipation.

Another purpose of the present invention is to provide a heat dissipation structure for blower motors that can prevent heat accumulation within the motor, effectively reducing the operating temperature of the motor, thereby reducing the risk of damage to the motor and extending the motor's service life.

In order to achieve these purposes, the present invention adopts the following technical means, comprising a motor and a fan assembly. The motor includes a motor housing that encloses an electric machine and an output shaft driven by the electric machine. The motor housing has multiple ventilation holes formed on both side walls, and at least one end of the output shaft extends through the motor housing wall. The fan assembly includes at least one impeller mounted on the end of the output shaft. Each impeller comprises a fan disc with multiple blades arranged equidistantly around its periphery. These blades form an internal annular chamber corresponding to the motor and an external annular chamber opposite the motor on both sides of the fan disc surface.

At least one impeller is equipped with an airflow directing assembly positioned within the internal annular chamber of the impeller fan disc adjacent to the motor. The airflow directing assembly has multiple airflow directing vanes arranged radially at equal angles. Each airflow directing vane has a cross-section at the end consisting of a thinner vane leading edge near the motor and a thicker vane trailing edge adjoining the fan disc surface.

By implementing these technical means, the heat dissipation structure of the present invention uses the airflow directing assembly installed on the impeller surface adjacent to the motor, along with the design of multiple airflow directing vanes. When the impeller rotates at high speed, each airflow directing vane uses its vane leading edge to guide the hot air discharged from the ventilation holes of the motor housing. The hot air is then carried away and dispersed by the impeller blades, preventing the formation of enclosed air chambers due to high-speed vortices. This design avoids heat accumulation within the motor, effectively reducing the motor's operating temperature, decreasing the risk of damage to the motor, and extending the service life of the motor. The present invention enhances utility, increases added value, and improves economic benefits.

Furthermore, the present invention implements the following technical means to further achieve the aforementioned purposes and effects:

The airflow directing vanes of the airflow directing assembly can be formed on the outer circumference of a circular mounting base. The circular mounting base has an axial hole at the center concentric with the fan disc, and multiple coupling through-holes arranged around the axial hole. The fan disc forms multiple corresponding coupling screw holes, enabling the circular mounting base of the airflow directing assembly to be secured to a fan disc surface adjacent to the motor housing using multiple fasteners.

The center of the fan disc has an axial hub, which enables the fan disc to be mounted securely on the output shaft of the motor via the axial hub.

The airflow directing assembly forms a circular mounting ring on the fan disc surface adjacent to the motor housing. This circular mounting ring is concentric with the fan disc, and the airflow directing vanes are arranged along the outer circumference of the circular mounting ring.

The center of the fan disc in the fan assembly is equipped with a hub protrusion, which enables the fan disc to be mounted securely on the output shaft of the motor via the hub protrusion.

The blades of the impeller are arcuately curved in a direction opposite to the rotation of the output shaft. Similarly, the airflow directing vanes are also arcuately curved with their concave sides facing in the opposite direction to the blades, creating a multi-angle guide surface on the concave surface of each airflow directing vane.

The motor can be a dual-shaft motor, with the output shaft being a double-ended output shaft extending through both side walls of the motor housing.

To enable a full understanding of the construction, features, and purposes of the present invention, several preferred embodiments are described below. These embodiments are presented with detailed description and drawings to provide concrete guidance for implementation to those skilled in the relevant art.

### BRIEF DESCRIPTION OF THE DRAWINGS

FIG. 1 is a schematic perspective view of a preferred embodiment of the present invention;

FIG. 2 is a schematic exploded perspective view of the preferred embodiment of the present invention, showing the configuration and relative arrangement of the main components;

FIG. 3 is a schematic sectional side view of the preferred embodiment of the present invention, showing the operational configuration and state;

FIG. 4 is a schematic perspective view of another preferred embodiment of the present invention;

FIG. 5 is a schematic exploded perspective view of another preferred embodiment of the present invention, showing the configuration and relative arrangement of the main components; and

FIG. 6 is a schematic sectional side view of another preferred embodiment of the present invention, showing the operational configuration and state.

### DETAILED DESCRIPTION OF THE PREFERRED EMBODIMENTS

In the specific embodiments and components of the present invention illustrated in the accompanying drawings, all references to “front” and “rear,” “left” and “right,” “top” and “bottom,” “upper” and “lower,” and “horizontal” and “vertical” are for descriptive purposes only and do not limit the invention or constrain its components to any particular position or spatial orientation. The dimensions specified in the drawings and specification may be adjusted as necessary based on the design and functional requirements of the present invention, within the scope defined by the patent claims.

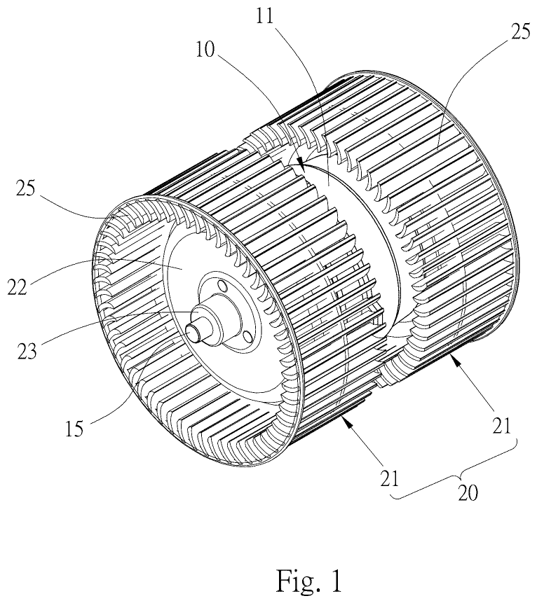

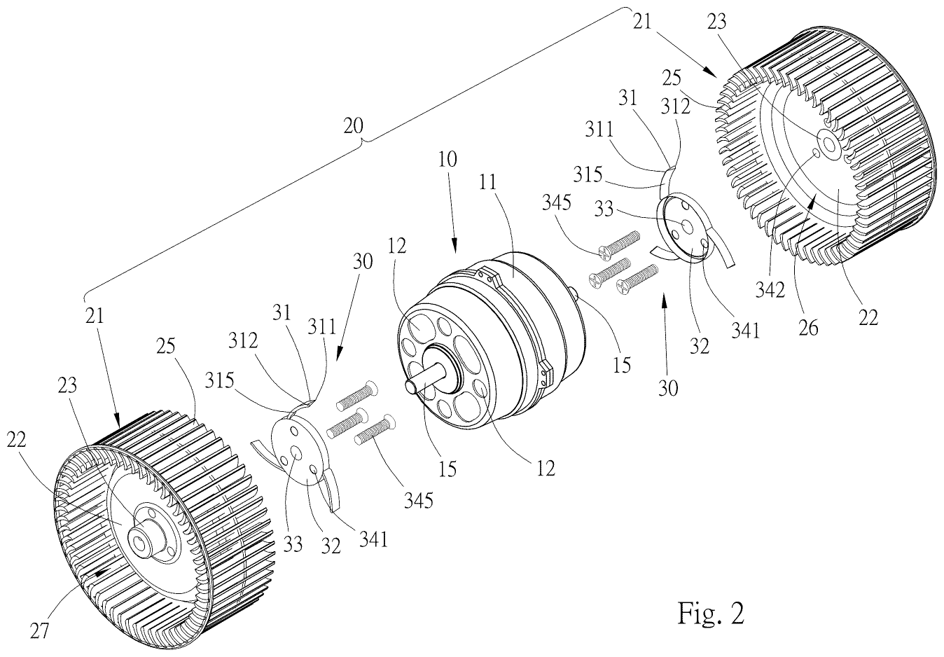

A heat dissipation structure for blower motors disclosed in the present invention is intended for use within a blower housing. As shown in FIGS. 1 and 2, the structure comprises a motor (10) and a fan assembly (20) that can be mounted inside the housing. During operation, the motor (10) drives the fan assembly (20) to rotate at high speed, drawing in external air through both sides of the housing and expelling the air through the top of the housing via centrifugal action.

The motor (10) includes a motor housing (11) enclosing an electric machine (not shown) and an output shaft (15) extending along the central axis of the electric machine. The motor housing (11) has multiple ventilation holes (12) formed on both side walls to facilitate the dissipation of heat generated by the electric machine during operation. The motor (10) can be a dual-shaft motor in which the output shaft (15) is designed as a double-ended shaft extending through both side walls of the motor housing (11). In the preferred embodiment of the present invention, the dual-shaft motor (10) with the double-ended output shaft (15) can provide optimum performance.

The fan assembly (20) consists of two opposed impellers (21) mounted on the respective ends of the output shaft (15) of the motor (10). Each impeller (21) comprises a fan disc (22) with an axial hub (23) located at the center, which enables the impeller (21) to be securely mounted on the output shaft (15). Multiple blades (25) are arranged equidistantly along the periphery of each fan disc (22). These blades (25) are arcuately curved in a direction opposite to the rotation of the output shaft (15). Furthermore, the blades (25) define an internal annular chamber (26) corresponding to the motor (10) and an external annular chamber (27) opposite the motor (10) on either side of the surface of the fan disc (22).

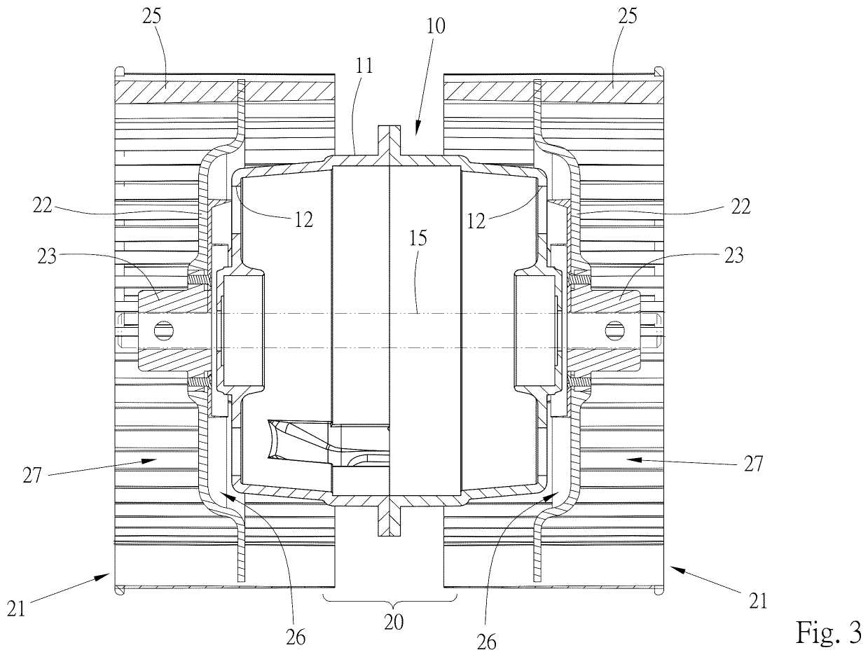

A distinguishing feature of this preferred embodiment of the present invention, as shown in FIGS. 2 and 3, is that at least one impeller (21) of the fan assembly (20) is equipped with an airflow directing assembly (30). The airflow directing assembly (30) is positioned within the internal annular chamber (26) of the fan disc (22) of the impeller (21) adjacent to the motor (10) and rotates synchronously with the impeller (21) at high speed. The airflow directing assembly (30) includes multiple airflow directing vanes (31) arranged radially at equal intervals. Each airflow directing vane (31) is arcuately curved, with its concave side facing in the opposite direction to the blade (25). Each airflow directing vane (31) has a cross-section at the end consisting of a thinner vane leading edge (311) near the motor (10) and a thicker vane trailing edge (312) adjoining the surface of the fan disc (22). This configuration forms a multi-angle guide surface (315) on the concave surface of the arcuate airflow directing vane (31). During high-speed rotation of the impeller (21), the guide surface (315) directs the hot air from the motor (10) outwardly through the ventilation holes (12) of the motor housing (11) (as shown in FIG. 3). The hot air is then carried away by the blades (25) of the impeller (21), effectively achieving heat dissipation and cooling.

Furthermore, the airflow directing vanes (31) of the airflow directing assembly (30) can be formed on the outer circumference of a circular mounting base (32). The circular mounting base (32) has an axial hole (33) corresponding to the axial hub (23) of the fan disc (22), through which the output shaft (15) is passed. In addition, the circular mounting base (32) forms multiple coupling through-holes (341) arranged around the axial hole (33), while the fan disc (22) forms corresponding coupling screw holes (342). This design enables the circular mounting base (32) of the airflow directing assembly (30) to be securely fastened to a surface of the fan disc (22) adjacent to the motor housing (11) using multiple fasteners (345).

Through this construction, an effective air-guiding and enhanced heat dissipation structure for blower motors is provided.

In practical applications of the blower motor heat dissipation structure, as shown in FIGS. 1, 2, and 3, the output shaft (15) of the motor (10) is equipped with the fan assembly (20), and the fan discs (22) of the impellers (21) on both sides include the airflow directing assemblies (30) installed on their surfaces within the internal annular chamber (26) adjacent to the motor (10), so that the airflow directing assemblies (30) can rotate at high speed in synchronism with the impellers (21). By utilizing the design of the multi-angle guide surface (315) of the airflow directing vanes (31) on each airflow directing assembly (30), hot air emitted from the ventilation holes (12) of the motor housing (11) is deflected by the vane leading edge (311) of each airflow directing vane (31). This air is further guided along the multi-angle guide surface (315) and carried away by the rotation of the blades (25) of the impeller (21), allowing the motor (10) to achieve effective heat dissipation and cooling, thereby extending the service life of the motor (10).

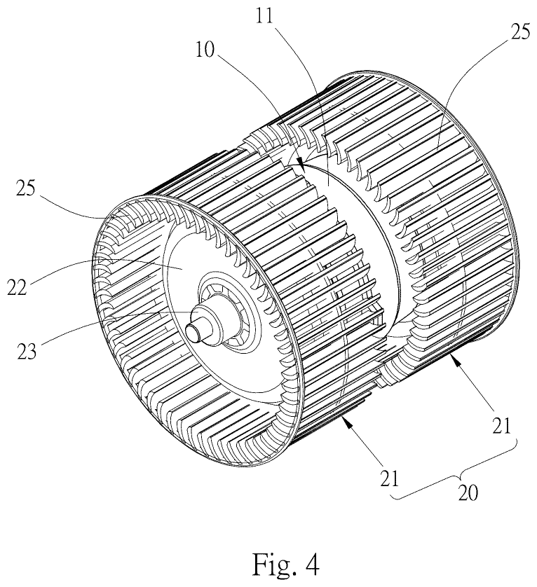

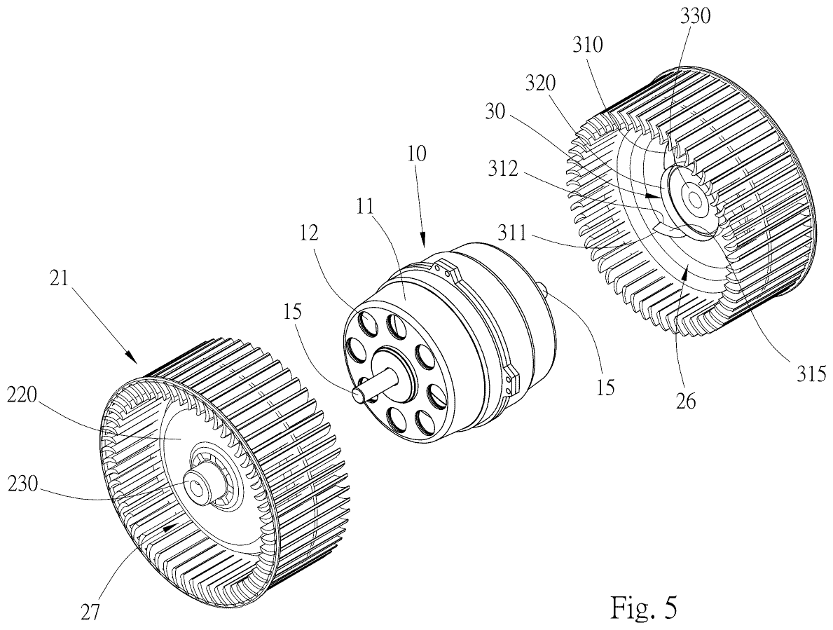

As shown in FIGS. 4, 5, and 6, which represent another preferred embodiment of the present invention, a fan assembly (20) comprises two opposing impellers (21) mounted on both ends of the output shaft (15). Each impeller (21) comprises a fan disc (220) with multiple blades (25) arranged equidistantly around its periphery. The center of the fan disc (220) is equipped with a hub protrusion (230), which allows the fan disc (220) to be secured to the end of the output shaft (15) of the motor (10) via the hub protrusion (230). Furthermore, the blades (25) also form an internal annular chamber (26) corresponding to the motor (10) and an external annular chamber (27) opposite the motor (10) on both sides of the fan disc (220).

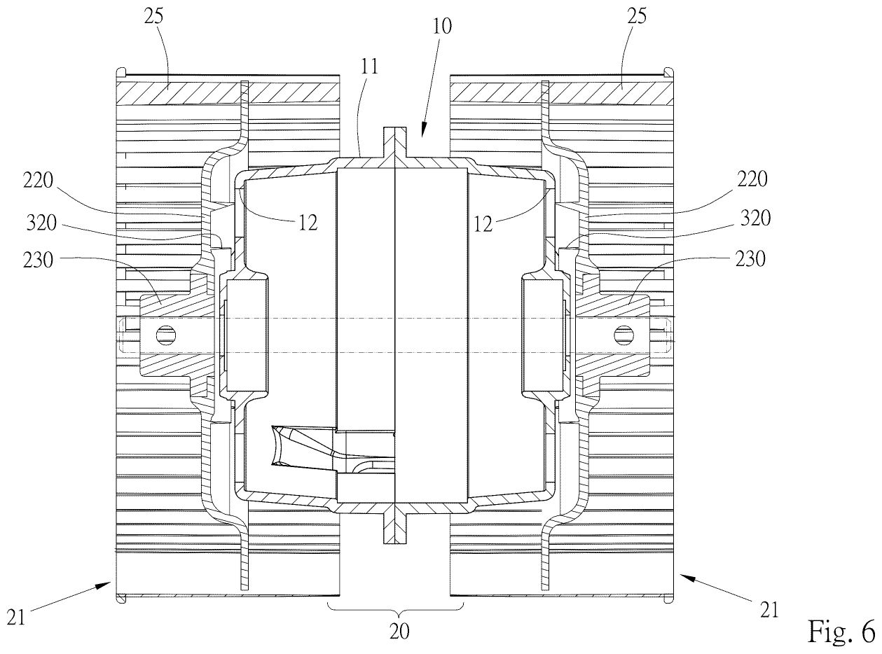

In addition, at least one of the impellers (21) integrally includes an airflow directing assembly (30) positioned on the surface of the fan disc (220) within the internal annular chamber (26) adjacent to the motor (10). The airflow directing assembly (30) forms a circular mounting ring (320) on the surface concentric with the fan disc (220). Multiple airflow directing vanes (310) are arranged radially at equal intervals along the outer circumference of the circular mounting ring (320). These airflow directing vanes (310) are arcuately curved, with their concave sides facing in the opposite direction to the blades (25). Each airflow directing vane (310) has a cross-section at the end consisting of a thinner vane leading edge (311) near the motor (10) and a thicker vane trailing edge (312) adjoining the surface of the fan disc (220). This configuration forms a multi-angle guide surface (315) along the concave side of the arcuate airflow directing vane (310). During high-speed rotation of the impeller (21), the guide surface (315) directs the hot air from the motor (10) outwardly through the ventilation holes (12) of the motor housing (11) (as shown in FIG. 6). The hot air is then carried away by the blades (25) of the impeller (21), effectively achieving heat dissipation and cooling.

From the foregoing, it is apparent that the present invention constitutes a highly innovative solution that effectively addresses the limitations of prior arts while significantly enhancing functionality. No identical or similar innovations or public disclosures in the same technical field have been identified. The present invention demonstrates a significant improvement in effectiveness and meets the criteria of “novelty” and “inventive step” required for invention patents. Therefore, the present invention is eligible for patenting.

What is claimed is:

1. A heat dissipation structure for blower motors, comprising a motor and a fan assembly, wherein:
the motor includes a motor housing enclosing an electric machine and an output shaft driven by the electric machine, the motor housing having multiple ventilation holes formed on both side walls, with at least one end of the output shaft extending through the motor housing wall; and
the fan assembly includes at least one impeller mounted on the end of the output shaft, each impeller comprising a fan disc with multiple blades arranged equidistantly around its periphery, the blades forming an internal annular chamber corresponding to the motor and an external annular chamber opposite the motor on both sides of the fan disc surface;
wherein at least one of the impellers is equipped with an airflow directing assembly positioned within the internal annular chamber of the impeller fan disc adjacent to the motor, the airflow directing assembly having multiple airflow directing vanes arranged radially at equal angles, and each airflow directing vane having a cross-section at the end consisting of a thinner vane leading edge near the motor and a thicker vane trailing edge adjoining the fan disc surface.

2. The heat dissipation structure for blower motors according to claim 1, wherein the airflow directing vanes of the airflow directing assembly are formed on the outer circumference of a circular mounting base, the circular mounting base having an axial hole at the center concentric with the fan disc, and multiple coupling through-holes arranged around the axial hole; the fan disc forms multiple corresponding coupling screw holes, enabling the circular mounting base of the airflow directing assembly to be secured to a fan disc surface adjacent to the motor housing using multiple fasteners.

3. The heat dissipation structure for blower motors according to claim 2, wherein the center of the fan disc has an axial hub, which enables the fan disc to be mounted securely on the output shaft of the motor via the axial hub.

4. The heat dissipation structure for blower motors according to claim 1, wherein the airflow directing assembly forms a circular mounting ring on the fan disc surface adjacent to the motor housing, the circular mounting ring being concentric with the fan disc, with the airflow directing vanes arranged along the outer circumference of the circular mounting ring.

5. The heat dissipation structure for blower motors according to claim 4, wherein the center of the fan disc is equipped with a hub protrusion, which enables the fan disc to be mounted securely on the output shaft of the motor via the hub protrusion.

6. The heat dissipation structure for blower motors according to claims 1, wherein the blades of each impeller are arcuately curved in a direction opposite to the rotation of the output shaft, and the airflow directing vanes are also arcuately curved with their concave sides facing in the opposite direction to the blades, creating a multi-angle guide surface on the concave surface of each airflow directing vane.

7. The heat dissipation structure for blower motors according to claims 2, wherein the blades of each impeller are arcuately curved in a direction opposite to the rotation of the output shaft, and the airflow directing vanes are also arcuately curved with their concave sides facing in the opposite direction to the blades, creating a multi-angle guide surface on the concave surface of each airflow directing vane.

8. The heat dissipation structure for blower motors according to claims 3, wherein the blades of each impeller are arcuately curved in a direction opposite to the rotation of the output shaft, and the airflow directing vanes are also arcuately curved with their concave sides facing in the opposite direction to the blades, creating a multi-angle guide surface on the concave surface of each airflow directing vane.

9. The heat dissipation structure for blower motors according to claims 4, wherein the blades of each impeller are arcuately curved in a direction opposite to the rotation of the output shaft, and the airflow directing vanes are also arcuately curved with their concave sides facing in the opposite direction to the blades, creating a multi-angle guide surface on the concave surface of each airflow directing vane.

10. The heat dissipation structure for blower motors according to claims 5, wherein the blades of each impeller are arcuately curved in a direction opposite to the rotation of the output shaft, and the airflow directing vanes are also arcuately curved with their concave sides facing in the opposite direction to the blades, creating a multi-angle guide surface on the concave surface of each airflow directing vane.

11. The heat dissipation structure for blower motors according to claim 6, wherein the motor is a dual-shaft motor, and the output shaft is a double-ended output shaft extending through both side walls of the motor housing.

12. The heat dissipation structure for blower motors according to claim 7, wherein the motor is a dual-shaft motor, and the output shaft is a double-ended output shaft extending through both side walls of the motor housing.

13. The heat dissipation structure for blower motors according to claim 8, wherein the motor is a dual-shaft motor, and the output shaft is a double-ended output shaft extending through both side walls of the motor housing.

14. The heat dissipation structure for blower motors according to claim 9, wherein the motor is a dual-shaft motor, and the output shaft is a double-ended output shaft extending through both side walls of the motor housing.

15. The heat dissipation structure for blower motors according to claim 10, wherein the motor is a dual-shaft motor, and the output shaft is a double-ended output shaft extending through both side walls of the motor housing.
